(19) United States
(12) Patent Application Publication
(10) Pub. No.: US 2002/0022924 A1
(43) Pub. Date: Feb. 21, 2002

(54) Propagation of position with multiaxis accelerometer

(76) Inventor: John David Begin, Sterling Heights, MI (US)

Correspondence Address: John E. Carlson, Carlson, Gaskey & Olds, P.C., Ste. 350, 400 W. Maple Rd., Birmingham, MI, 48009, US

(21) Appl. No.: 09/800,609

(22) Filed: Mar. 7, 2001

Related U.S. Application Data
(60) Provisional application No. 60/187,552, filed on Mar. 7, 2000.

(51) Int. Cl. G01C 21/26

(52) U.S. Cl. 701/207; 701/220

(57) ABSTRACT

A vehicle navigation system and method for propagating a position of a vehicle utilizing a multiaxis accelerometer determines the pitch and roll of the vehicle without utilizing gyros and utilizes the calculated pitch and roll to propagate the position of the vehicle with the acceleration signals from the multiaxis accelerometer. This occurs in one of three situations (in order of complexity): 1) when the vehicle is not moving; 2) when the vehicle is moving and other speed and/or heading information is available and 3) when the vehicle is moving and other speed and/or heading information is not available.

This application claims priority from provisional application Ser. No. 60/187,552 filed Mar. 7, 2000.

The present invention relates generally to vehicle navigation systems and more particularly to a vehicle navigation system propagating position with a multiaxis accelerometer.

A known vehicle navigation system utilizes multiple sensors to propagate position of the vehicle relative to a database of roads. The sensors include gyros and accelerometers, including a multiaxis accelerometer. Generally, the multiaxis accelerometer includes three orthogonal accelerometers, each oriented along an axis of the vehicle. The first accelerometer is oriented along a longitudinal axis of the vehicle, a second accelerometer is oriented vertically in the vehicle and a third accelerometer is mounted orthogonally to the first two, along the lateral axis of the vehicle.

Generally, acceleration of the vehicle along the longitudinal axis is measured by the first accelerometer and can be used to determine a current vehicle speed. Lateral acceleration, together with vehicle speed, can be used to determine a change in heading of the vehicle. Orthogonally mounted gyros in the vehicle are utilized to measure a change in pitch and change in heading of the vehicle.

Information from the gyros is utilized to distinguish changes in pitch and roll from longitudinally and lateral acceleration, respectively. For example, if the vehicle is traveling on a road rolled slightly to the right, this will induce a signal in the lateral accelerometer which would indicate a slight left turn. This can be resolved by information from the roll gyro, which would confirm that the vehicle is not turning, but must be slightly rolled. Similarly, if the vehicle is traveling up a hill, gravity would induce some acceleration in the longitudinal accelerometer, which could be interpreted as acceleration by the vehicle in the longitudinal direction. This is also corrected by information from the pitch gyro confirming that the vehicle has changed pitch.

The gyros add cost, size and weight to the vehicle navigation system. It is desirable to eliminate the gyros without sacrificing accuracy of the propagated position of the vehicle navigation system. Generally, this requires determining the pitch and roll of the vehicle without the use of gyros.

### SUMMARY OF THE INVENTION

The present invention provides a vehicle navigation system and method for propagating a position of a vehicle utilizing a multiaxis accelerometer. The inventive navigation system and method determines the pitch and roll of the vehicle without utilizing gyros and utilizes the calculated pitch and roll to propagate the position of the vehicle with the acceleration signals from the multiaxis accelerometer. This occurs in one of three situations (in order of complexity): 1) when the vehicle is not moving; 2) when the vehicle is moving and other speed and/or heading information is available and 3) when the vehicle is moving and other speed and/or heading information is not available.

The pitch and roll of the vehicle can first be determined when the vehicle is in a zero motion state. When the vehicle is in a zero motion state, the resultant acceleration vector from the multiaxis accelerometer should have a magnitude of 1G. The direction of the resultant acceleration vector should be straight down relative to the Earth. To the extent the resultant vector does not coincide with the vertical axis of the vehicle, the pitch and roll of the vehicle can be determined.

Determining the pitch and roll of the vehicle while the vehicle is moving is more difficult. Generally, the navigation system must distinguish pitch of the vehicle from longitudinal acceleration of the vehicle and distinguish roll of the vehicle from lateral acceleration of the vehicle. Pitch and roll of the vehicle are determined by comparing information from the multiaxis acclerometer to other speed and/or heading information, such as GPS information (such as GPS speed and heading information) and/or analysis of map matching information. When GPS is available, GPS velocity (speed and heading) is accurate for speeds over 1.5 m/s. Map matching also provides accurate heading information. It is determined that lateral acceleration information from the multiaxis accelerometer represents vehicle roll rather than change in heading if the GPS velocity information and/or map matching information indicate that the heading has not changed. Similarly, GPS velocity information and map matching heading information may alternatively indicate that the vehicle is changing heading, rather than vehicle roll. In either event, if the availability of the GPS signal is subsequently lost, the multiaxis accelerometer can continue to propagate the vehicle position more accurately because it has determined the pitch and roll of the vehicle. Similarly, by comparing the GPS velocity information to the signal from the longitudinal accelerometer of the multiaxis accelerometer, the navigation system determines whether the vehicle is accelerating or is pitched.

Pitch and roll (“attitude”) of the vehicle is also determined solely by the multiaxis accelerometer even when GPS velocity information and map matching information is not available. The pitch and roll of the vehicle is determined by the multiaxis accelerometers when gravity is substantially the only acceleration acting upon the multiaxis accelerometer. A vehicle could be moving, but is not changing heading, speed, pitch or roll. When the resultant vector from the orthogonal accelerometers and the multiaxis accelerometer is substantially 1G and is substantially constant for a period of time (1 to 5 seconds), the pitch and roll of the vehicle can be determined by comparison of the vehicle axes to the 1 G resultant vector.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic of the navigation system of the present invention installed in a vehicle;

FIG. 2 is a logic chart for the attitude estimation logic for the navigation system of FIG. 1;

FIG. 3 is a logic chart for the accelerometers and synthesized rate gyros of the navigation system of FIG. 1; and

FIG. 4 is a flow chart for propagating position according to the present invention in the navigation system of FIG. 1.

### DETAILED DESCRIPTION

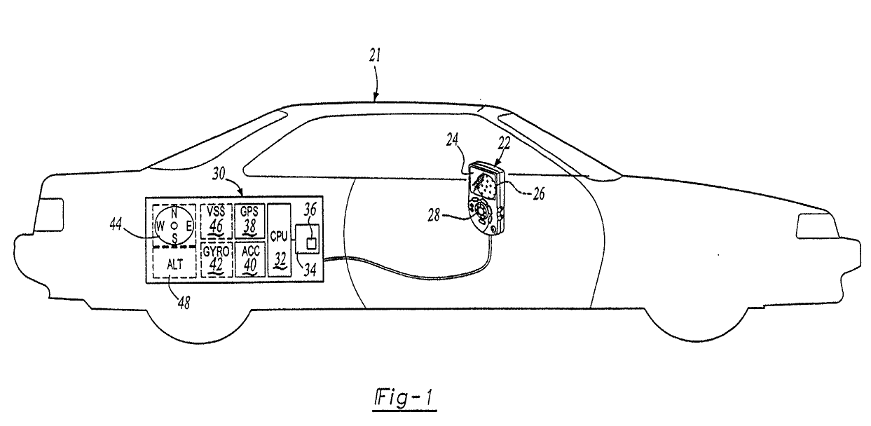

The navigation system 20 of the present invention is shown schematically in FIG. 1 installed in a vehicle 21. The navigation system 20 includes an Operator Interface Module (“OIM”) 22 including input and output devices. The OIM 22 includes a display 24, such as a high resolution LCD or flat panel display, and an audio speaker 26. The OIM 22 also includes input devices 28, preferably a plurality of buttons and directional keypad, but alternatively including a mouse, keyboard, keypad, remote device or microphone. Alternatively, the display 24 can be a touch screen display.

The navigation system 20 further includes a computer module 30 connected to the OIM 22. The computer module 30 includes a CPU 32 and storage device 34 connected to the CPU 32. The storage device 34 may include a hard drive, CD ROM, DVD, RAM, ROM or other optically readable storage, magnetic storage or integrated circuit. The storage device 34 contains a database 36 including a map of all the roads in the area to be traveled by the vehicle 21 as well as the locations of potential destinations, such as addresses, hotels, restaurants, or previously stored locations. The software for the CPU 32, including the graphical user interface, route guidance, operating system, position-determining software, etc may also be stored in storage device 34 or alternatively in ROM, RAM or flash memory.

The computer module 30 preferably includes navigation sensors, such as a GPS receiver 38 and an inertial sensor, which is preferably a multi-axis accelerometer 40. The computer module 30 may alternatively or additionally include one or more gyros 42, a compass 44, a wheel speed sensor 46 and altimeter 48, all connected to the CPU 32. Such position and motion determining devices (as well as others) are well known and are commercially available.

The navigation system 20 propagates the position of the vehicle 21 relative to the map database 36, i.e. relative to road segments and intersections. The navigation system 20 also determines the current location of the vehicle 21 in terms of latitude and longitude. Generally, the CPU 32 and position and motion determining devices determine the position of the vehicle 21 relative to the database 36 of roads utilizing dead reckoning, map-matching, etc. Further, as is known in navigation systems, the user can select a destination relative to the database 36 of roads utilizing the input device 28 and the display 24. The navigation system 20 then calculates and displays a recommended route directing the driver of the vehicle 21 to the desired destination. Preferably, the navigation system 20 displays turn-by-turn instructions on display 24 and gives corresponding audible instructions on audio speaker 26, guiding the driver to the desired destination.

Preferably, the GPS receiver 38 provides speed and heading information to the CPU 32 utilizing the technique described in co-pending U.S. application Ser. No. 08/579,902, entitled “Improved Vehicle Navigation System and Method Using GPS Velocities,” which is hereby incorporated by reference in its entirety.

Although the navigation system 20 of the present invention could include a variety of different combinations of different sensors and utilize a variety of different techniques for propagating the position of the vehicle 21, the present invention relates specifically to the use of the multi-axis accelerometer 40. It should be understood that some details would vary based upon the other sensors available and the specific techniques selected. For purposes of illustration, propagation of position using the multi-axis accelerometer 40 will be described with the benefit of the GPS receiver 38, although other sensors could also be utilized.

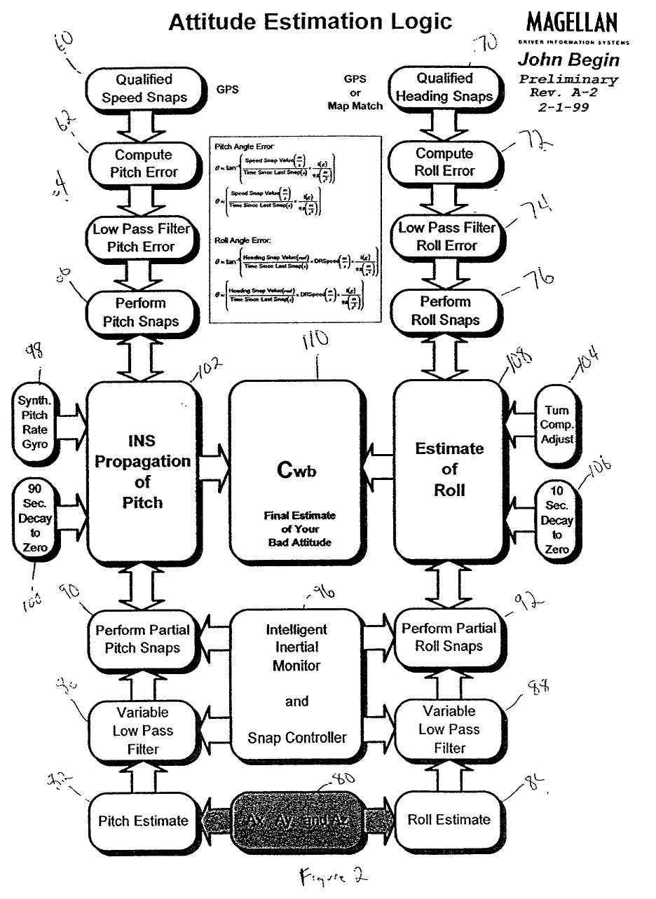

FIG. 2 is a flow chart for the attitude estimation logic. In step 60 qualified speed snaps are received from the GPS receiver 38 in accordance with the technique described in U.S. Pat. No. 6,029,111 entitled “Improved Vehicle Navigation System and Method Using GPS Velocities.” Generally, the speed snaps from the GPS receiver 38 are accurate for speeds over 1.5 m/s. In step 62, the pitch error is computed according to the formula shown.

In step 64, a low pass filter is applied to the pitch angle error, preferably 3 Hz. In step 66, pitch snaps are performed, snapping the pitch value. Similarly, with respect to calculation of roll angle error, in step 70, qualified heading snaps are taken. Again, these heading snaps can be from GPS in accordance with the technique described in U.S. Pat. No. 6,029,111 or utilizing known map matching techniques. The roll error is then calculated in step 72 utilizing equations shown. A low pass filter is then applied to the roll error in step 74, preferably 3 Hz. In step 76, the roll snaps are performed.

Concurrently, in step 80, the linear accelerations are measured by the multiple axis accelerometer 40 (FIG. 1) from which linear accelerations relative to the vehicle frame are determined: Aₓ (forward acceleration), A_{y} (acceleration toward the right), and A_{z} (acceleration down).

From these linear accelerations, pitch and roll are estimated in steps 82 and 84, respectively, in the manner which will be described below. Low pass filters are applied to the pitch and roll estimates in steps 86 and 88, respectively. Partial snaps are performed of the pitch and roll values in steps 90 and 92 respectively. The intelligent inertial monitor and snap controller 96 controls the snaps in steps 90 and 92 and the variable low pass filters 86, 88.

The synthesized pitch rate gyro 98 and a 90 second decay to zero 100 are input to the INS propagation of pitch 102. The 90 second decay to zero 100 automatically gradually returns the calculated pitch back to zero in 90 seconds. The INS propagation of pitch 102 also receives pitch snaps from step 66 and partial pitch snaps from step 90.

A turn compensation adjustment 104 and a 10 second decay to zero 106 are input to the estimate of roll 108, as are the roll snaps 106 and partial roll snaps 92. The 10 second decay to zero 106 automatically gradually returns the calculated roll back to zero in ten seconds. The propagation of pitch 102 and estimate of roll 108 together give the estimate of attitude 110.

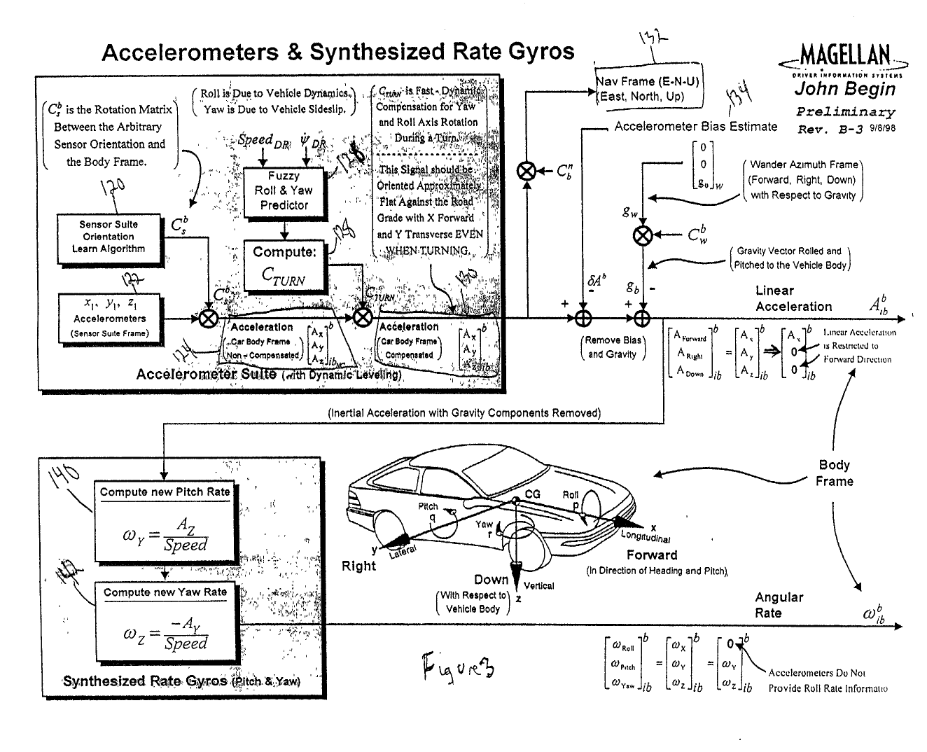

FIG. 3 is the logic flow chart for the accelerometers and synthesized rate gyros. Element 120 is the sensor suite orientation learn algorithm which calculates the rotation matrix C^{b}ₛ rotation matrix between the arbitrary sensor orientation and the body frame (forward, right, down). The rotation matrix converts the accelerometer signals 122 to the non-compensated car body frame linear acceleration signals in step 124. The dead-reckoned speed and heading are input to a fizzy roll and yaw predictor 166. Based upon the fuzzy roll and yaw protector 126, C_{TURN} is computed in step 128. C_{TURN} is a fast, dynamic compensation for yaw and roll access rotation during a turn. During a turn, roll is due to vehicle dynamics and yaw is due to vehicle side-slip. C_{TURN} is then applied to the non-compensated car body frame signal 124 to give the compensated car body frame acceleration 130, which is oriented approximately flat against the road grade with x forward and y transverse even when turning, thus removing the effects of roll due to vehicle dynamics and yaw due to vehicle side slip.

The compensated car body frame acceleration 130 can be converted to the navigation frame 132 by Cⁿ_{b}. The accelerometer bias estimate 134 is removed from the compensated car body frame acceleration signals 130 and gravity in the wander azimuth frame (forward right down with respect to gravity) is converted to the body frame by C^{b}_{w} and also removed from the acceleration signals. These linear acceleration signals (forward, right, down with respect to the vehicle body) are used to generate the linear forward acceleration Aₓ, from which the speed of the vehicle can be determined. A new pitch rate ω_{Y} is calculated in step 140 as the linear acceleration downward A_{z} divided by the speed of the vehicle. Similarly, the yaw rate ω_{Z} is calculated as the negative lateral acceleration divided by the speed of the vehicle. ω_{Y} and ω_{Z} are the synthesized rate gyros which can determine pitch and yaw.

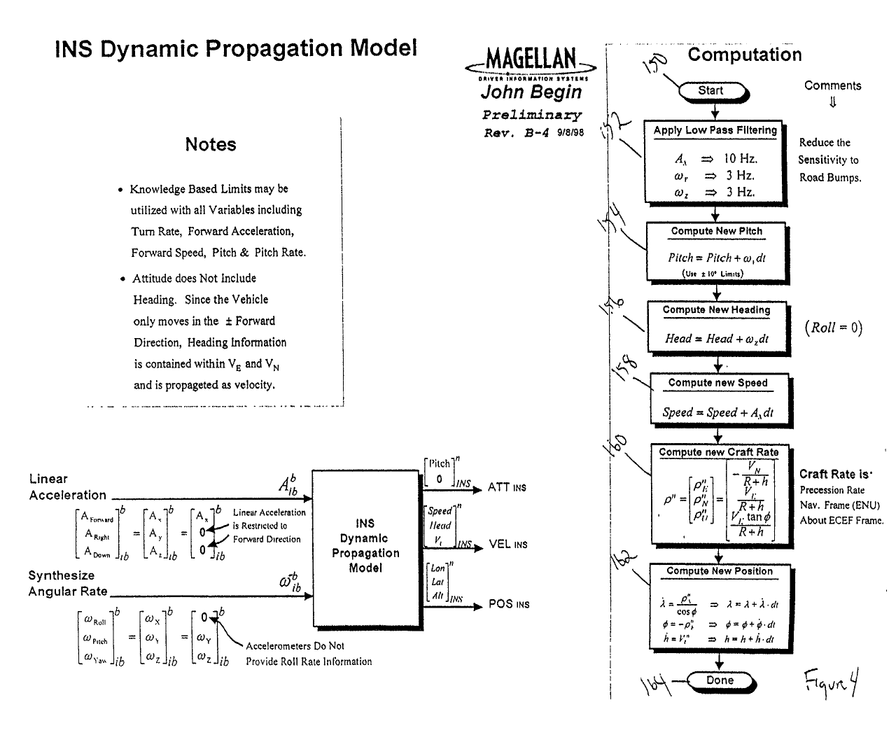

The forward acceleration Aₓ and synthesized rate gyros ω_{Y} and ω_{Z} are used in the flow chart of FIG. 4, starting in step 150. Low pass filtering is applied in step 152. Preferably, a 10 Hz low pass filter is applied to the forward acceleration Aₓ while a 3 Hz low pass filter is applied to both the pitch and yaw rates ω_{Y} and ω_{Y} The new pitch is calculated in step 154 as the previously calculated pitch plus the pitch rate ω_{Y} times the elapsed time. Preferably, the pitch calculation is limited to plus or minus 10 degrees.

In step 156, the new heading is calculated as the previously calculated heading plus ω_{Z} time the elapsed time. In step 158, the new speed is calculated as the old speed plus the forward acceleration Aₓ, times the elapsed time.

What is claimed is:

1. A method of propagating a previous position to a current position in a vehicle navigation system, said method including the steps of:
a) providing longitudinal acceleration information;
b) providing vertical acceleration information;
c) determining a pitch of the vehicle from said vertical acceleration information and said longitudinal acceleration information; and
d) using said pitch to propagate a previous position to a current position.

2. The method of claim 1 further including the step of determining a change in said pitch from said vertical acceleration information and said longitudinal acceleration information.

3. The method of claim 2 wherein said step c) is performed without information from a rotation sensor.

4. A method of propagating a previous position to a current position in a vehicle navigation system, said method including the steps of:
a) providing longitudinal acceleration information and vertical acceleration information;
b) providing heading information; and
c) determining roll of the vehicle based upon said vertical acceleration information, said longitudinal acceleration information and said heading information.

5. The method of claim 4 further including the step of using said heading to propagate a previous position to a current position.

6. The method of claim 5 further including the step of using said heading to propagate a previous position to a current position

7. The method of claim 4 further including the step of obtaining said heading information from map-matching.

8. The method of claim 4 further including the step of obtaining said heading information from GPS velocity information .

9. The method of claim 4 wherein said step c) is performed without information from a gyro.

10. A method of propagating a previous position to a current position in a vehicle navigation system, said method including the steps of:
a) providing longitudinal acceleration information and vertical acceleration information;
b) providing speed information; and
c) determining pitch based upon said vertical acceleration information, said longitudinal acceleration information and said speed information

11. The method of claim 10 further including the step of using said pitch to propagate a previous position to a current position.

12. The method of claim 11 further including the step of obtaining said speed information from GPS velocity information.

13. A method for propagating a previous position to a current position in a vehicle navigation system, said method including the steps of:
a) receiving a plurality of signals from an inertial sensor mounted in a vehicle;
b) determining a pitch of the vehicle based upon the plurality of signals; and
c) propagating a previous position to a current position based upon the plurality of signals and said pitch as determined in said step b).

14. The method of claim 13 wherein said steps a) and b) are performed while the vehicle is moving.

15. The method of claim 13 further including the steps of:
e) determining whether the vehicle is not moving; and
f) performing said steps a) and b) based upon said step e) when said vehicle is not moving.

16. The method of claim 13 further including the steps of:
d) monitoring the plurality of signals to determine a low noise situation; and
e) performing said step b) based upon said step d).
